(19) United States
(12) Patent Application Publication
(10) Pub. No.: US 2004/0261009 A1
(43) Pub. Date: Dec. 23, 2004

(54) Electronic document significant updating detection apparatus, electronic document significant updating detection method; electronic document significant updating detection program, and recording medium on which electronic document significant updating detection program is recording

(75) Inventors: Shin Torigoe, Osaka (JP); Atsushi Ikeno, Kyoto (JP)

Correspondence Address: VENABLE, BAETJER, HOWARD AND CIVILETTI, LLP, P.O. BOX 34385, WASHINGTON, DC, 20043-9998, US

(73) Assignee: Oki Electric Industry Co., Ltd., Tokyo (JP)

(21) Appl. No.: 10/602,725

(22) Filed: Jun. 25, 2003

(30) Foreign Application Priority Data
Jun. 27, 2002 (JP) JP2002-187859
Mar. 3, 2003 (JP) JP2003-55617

(51) Int. Cl. G06F 15/00

(52) U.S. Cl. 715/500

(57) ABSTRACT

In this invention, an electronic document to be detected and an electronic document to be compared are loaded, and a difference between important parts of the electronic document to be detected and the electronic document to be compared is detected. The difference between the important parts is obtained by (1) performing difference detection after the important parts are extracted from the electronic documents, (2) checking whether the differences are significant differences or not after the difference between both the entire electronic documents, or (3) performing difference detection after the important parts of the electronic documents are extracted and determining whether the difference is a significant difference or not.

### BACKGROUND OF THE INVENTION

The present invention relates to an electronic document significant detection apparatus, method, and program, and a recording medium on which an electronic document significant updating program is recorded. For example, the present invention can be applied to a system which monitors updating of an electronic document such as a Web page or a text to notify a user that the electronic document is updated.

### DESCRIPTION OF THE RELATED ART

In a conventional technique, Web pages related to the same URL are appropriately updated. A scheme for detecting the updating of the Web pages, a scheme disclosed in Patent Document 1 is known. The checksums of target Web pages are compared with each other. If the checksums change, it is considered that the Web pages are updated. [Patent Document 1] Japanese Patent Laid-open Publication No. 2000-35913

However, in the above scheme, even though a slight adjustment (e.g., typographical errors, omissions, corrections, and the like) of a sentence or parts (e.g., an advertisement column, other small catch letters, and the like) which are not related are updated, it is detected that the Web pages are updated. For this reason, many users who expect significant updating obtain unnecessary results.

Therefore, an electronic document significant updating detection apparatus and the like which can detect updating the level of which is equal to the level of updating of an electronic document is desired.

### SUMMARY OF THE INVENTION

An electronic document significant updating detection apparatus includes: input means for loading an electronic document to be detected and an electronic document to be compared; and significant updating detection means for detecting a difference between an important part of the input electronic document to be detected and an important part of the input electronic document to be compared.

An electronic document significant updating detection method includes: the input step of loading an electronic document to be detected and an electronic document to be compared; and the significant updating detection step of detecting a difference between an important part of the input electronic document to be detected and an important part of the input electronic document to be compared.

In an electronic document significant updating detection program according to the present invention, the steps of the electronic document significant updating detection method according to the present invention is described by a code which can be processed by a computer.

A recording medium according to the present invention records the electronic document significant updating detection program according to the present invention thereon.

### BRIEF DESCRIPTION OF THE DRAWINGS

FIG. 1 is a block diagram showing a functional configuration of an electronic document significant updating detection apparatus according to the first embodiment.

FIG. 2 is a diagram for explaining a Web page which has not been updated.

FIG. 3 is a diagram for explaining an updated Web page corresponding to the Web page in FIG. 2.

FIG. 4 is a diagram for explaining an interested-part table used for predesignating a frame in the first embodiment.

FIG. 5 is a diagram for explaining an interested frame on the Web page in the first embodiment.

FIG. 6 is a diagram for explaining a method of extracting a summary (important sentence) in the first embodiment.

FIG. 7 is a diagram for explaining keywords obtained by a pre-process serving as a keyword extraction process in the first embodiment.

FIG. 8 is a block diagram of a functional configuration of an electronic document significant updating detection apparatus according to the second embodiment.

FIG. 9 is a diagram for explaining an operation in the second embodiment.

### DETAILED DESCRIPTION OF THE PREFERRED EMBODIMENTS

(A) First Embodiment

The first embodiment of an electronic document significant updating detection apparatus, method, and program according to the present invention and a recording medium on which the electronic document significant updating detection program is recorded will be described below with reference to the accompanying drawings.

(A-1) Configuration of First Embodiment

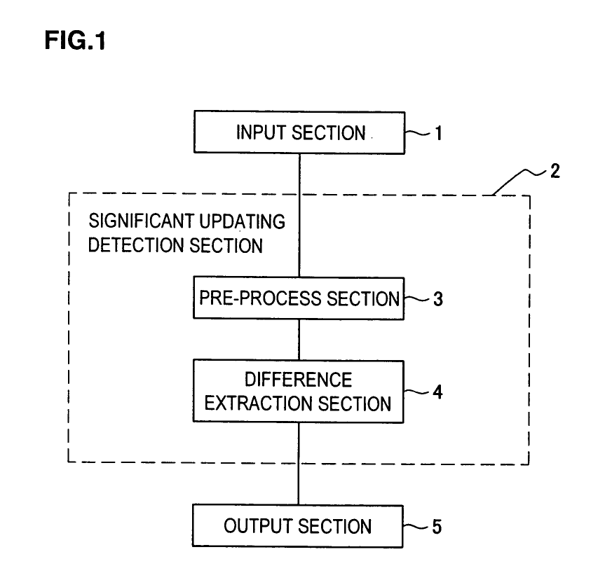

FIG. 1 is a block diagram showing a functional configuration of an electronic document significant updating detection apparatus according to the first embodiment.

For example, although the electronic document significant updating detection apparatus according to the first embodiment is realized on an information processing apparatus such as a user's personal computer having a communication function, a provider server, or the like, the electronic document significant updating detection apparatus can be functionally shown in FIG. 1. For example, an electronic document significant updating detection program recorded on a recording medium such as a CD-ROM or a flexible disk is installed in an information processing apparatus such as a personal computer, a provider server, or the like, so that the electronic document significant updating detection apparatus according to the first embodiment will be structured. In practice, the electronic document significant updating detection apparatus may be structured on one system, or may be structured such that electronic document significant updating detection apparatuses on servers which are connected to each other through a network cooperatively operate.

The electronic document significant updating detection apparatus according to the first embodiment has an input section 1, a significant updating detection section 2, and an output section 5. The significant updating detection section 2 has a pre-process section 3 and a difference extraction section 4.

The input section 1 acquires an electronic document such as a Web page or a text from a network such as the Internet or an intranet or a recording medium such as a CD-ROM to use the electronic document as input data.

When the input section 1 can pick up two electronic documents, i.e., an electronic document to be detected with respect to significant updating and an electronic document to be compared such that versions of the documents are designated, the input section 1 can simultaneously pick up the two documents. In addition, an electronic document which was picked up by designating the URL of the electronic document may be picked up as an electronic document, and an electronic document which is picked up by the same URL at this time may be picked up as an electronic document to be detected with respect to significant updating. Furthermore, two new and old documents which were picked up and stored at different past times may be input as an electronic document to be detected and an electronic document to be compared.

The significant updating detection section 2 detects a significant updating part of an electronic document to be detected for an electronic document to be compared. In the significant updating detection section 2, the pre-process section 3 extracts important parts from electronic documents, and the difference extraction section 4 extracts a difference between text strings in the important parts extracted by the pre-process section 3.

The important parts of the electronic documents are, for example, the texts of the electronic documents or main sentences (including summaries thereof) in the texts or titles. Other parts (e.g., advertisement columns, other small catch letters, and the like) which are not related to the important parts are set as unimportant parts.

As a method of extracting an important part of an electronic document by the pre-process section 3, a conventional method can be applied. An important part may be decided, and an important part may be specified by a user.

For example, a Web page is described by HTML, XML, or the like, and one image is formed by a plurality of frames. However, an important part (frame part) can be decided by tag identifiers (e.g., “MAIN”) for defining frame parts, the areas of the frame parts, the numbers of characters in the frame parts, or the arrangement positions of the frames or by checking whether the frame parts include a predetermined keyword or not.

As a method of extracting a difference between text strings in the difference extraction section 4, a conventional method can also be applied.

When an electronic document such as a Web page is significantly updated, the output section 5 displays that the electronic document is significantly updated on a display device or notifies a user of updating contents by an electronic mail. Output contents may include contents obtained before and after the updating or may be updated contents having an updated part. The output contents may be output in an arbitrary output form.

(A-2) Operation of First Embodiment

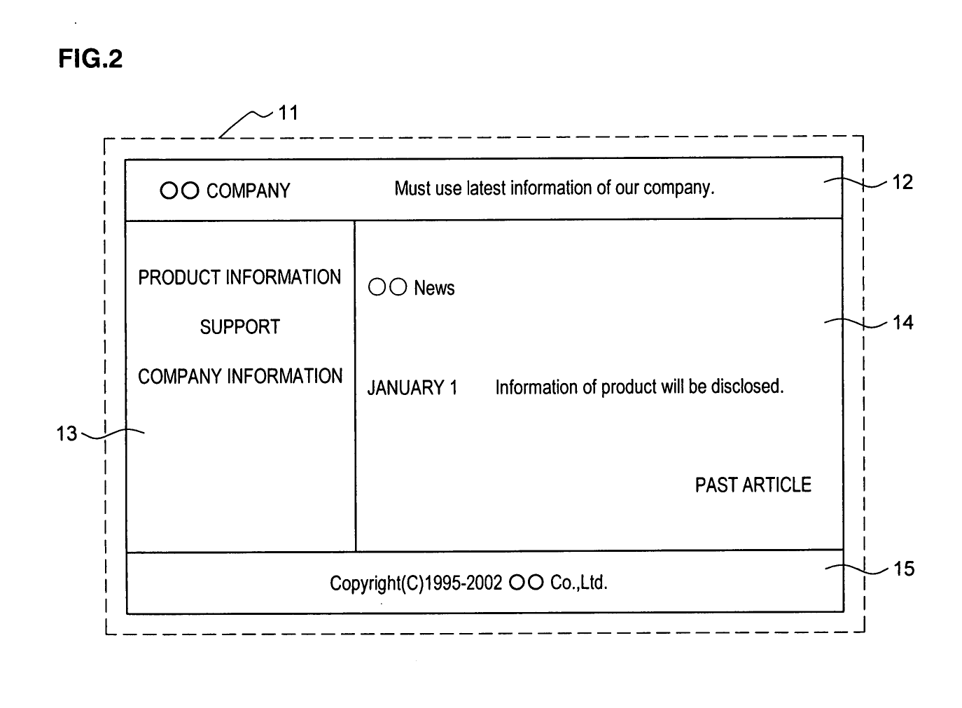

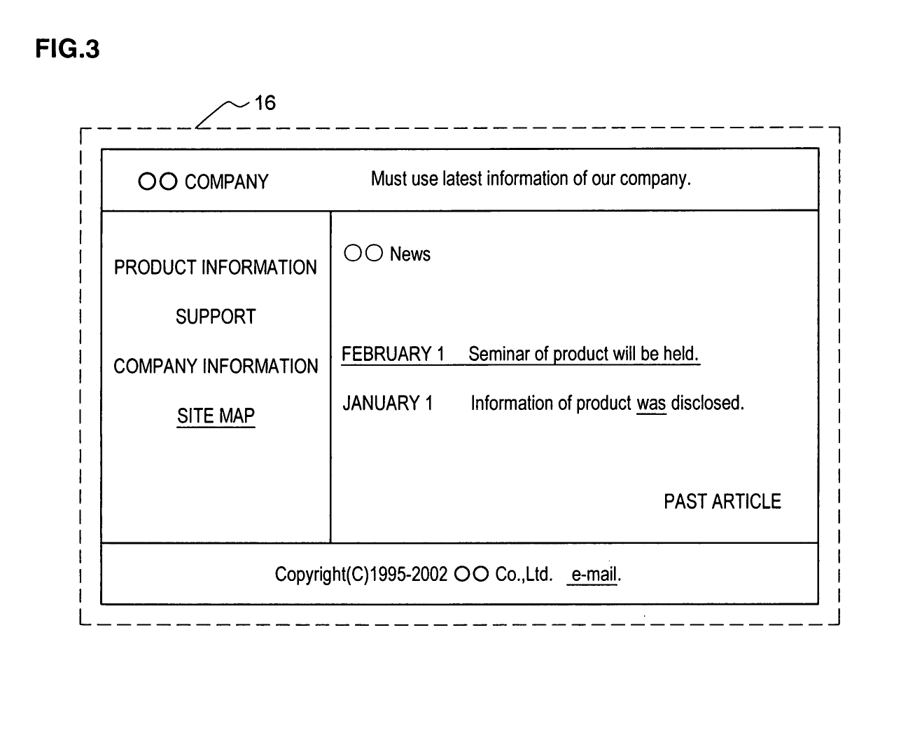

The detailed processes of the first embodiment will be described below with reference to imaginary Web pages obtained before and after updating. FIG. 2 shows a Web page obtained before updating, and FIG. 3 shows a Web page obtained after updating. Although FIG. 1 described above is a functional block diagram, FIG. 1 can also be regarded as a flow chart showing a flow of processes.

Reference numeral 11 denotes a display of a Web page obtained before updating by a browser, and reference numeral 16 denotes a display of a Web page obtained after updating by the browser. On the Web page 16 obtained after updating, for the sake of convenience, in order to clearly specify an updated part, an underline is added to the updated part, and no underline is added to the Web page itself.

The Web pages 11 and 16 obtained before and after updating are constituted by four frames 12 to 15 (see FIG. 2) which correspond to a header, a menu, an article, and a footer, respectively.

The input section 1 loads the Web pages 11 and 16 obtained after and before updating and shown in FIGS. 2 and 3 to give the Web pages 11 and 16 to the significant updating detection section 2.

The significant updating detection section 2 includes the pre-process section 3 and the difference extraction section 4. In the pre-process section 3, important parts are extracted from target documents, and the extracted parts are compared with each other by the difference extraction section 4.

As a method of extracting an important part by the pre-process section 3, for example, various methods such as advance designation of a frame by a user and summarization (extraction of important sentence) are known. In the following description, an example which uses an advance designation method of a frame by a user and an example in which a summary (extraction of important sentence) is extracted will be explained.

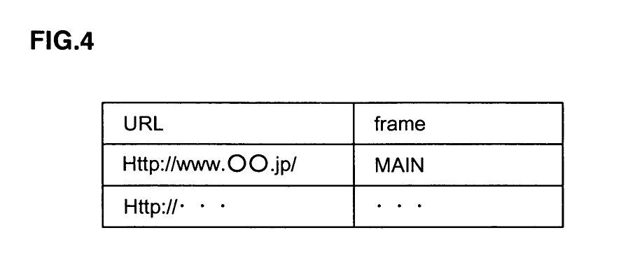

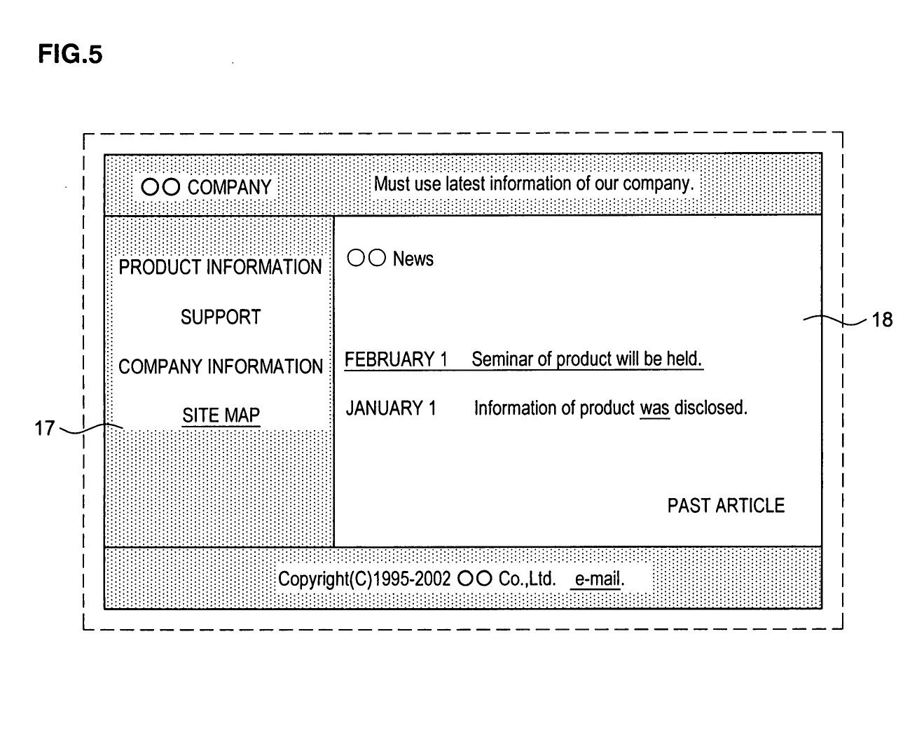

In the advance designation of a frame by a user, an interest part table as shown in FIG. 4 is used to designate the URL of a Web page which is desired by a user to be monitored and a part (frame) which is desired by the user to be updated. In the pre-process section 3, on the basis of this information, a specific frame in the target Web page is extracted to transmit only the specific frame to the difference extraction section 4. A process image at this time is shown in FIG. 5. A frame group 17 shows a group of frames which are not designated in FIG. 4 and a frame group 18 shows a frame which are designated and extracted in FIG. 4. FIG. 5 shows an extracted image of the updated Web page. Although not shown, the same extraction is also performed to the Web page obtained before updating.

The difference extraction section 4 extracts a difference between frames 18 of the Web pages obtained after and before updating. An underlined part of the frame 18 shown in FIG. 5 denotes a difference part extracted by the difference extraction section 4 on the updated Web page.

On the other hand, the summary extraction (important sentence extraction) method is a method for extracting a sentence which is supposed to be important from a character string in a document. For example, the method disclosed in Japanese Patent Laid-open Publication No. 11-272686 can be applied. The pre-process section 3 extract a character string (sentence) which is supposed to be important to transmit the character string to the difference extraction section 4.

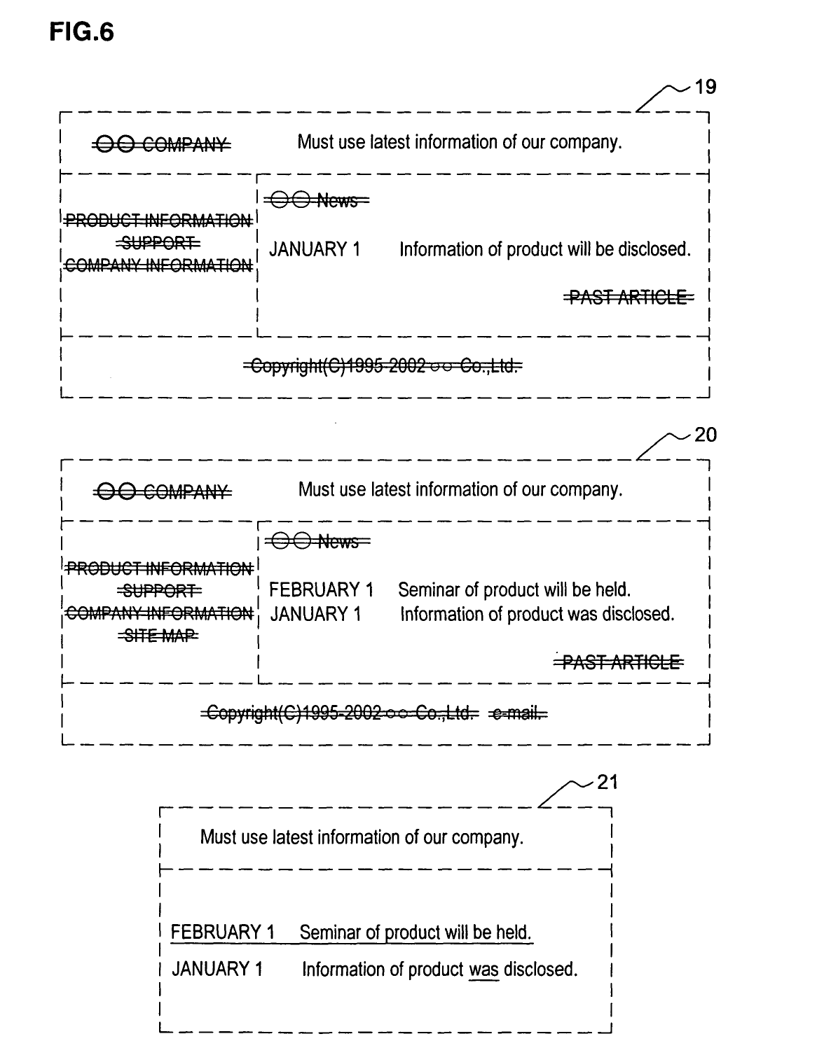

A process image obtained at this time is shown in FIG. 6. In FIG. 6, reference numerals 19 and 20 denote summary extraction results of the Web pages obtained after and before updating by the pre-process section 3. In process images 19 and 20 in FIG. 6, character strings which are determined as unimportant character strings are erased by double lines. However, this makes it easy to understand the character strings. These character strings are not extracted because the character strings are not important, and are not given to the difference extraction section 4.

In FIG. 6, reference numeral 21 denotes a difference extraction result obtained by the difference extraction section 4. The difference extraction section 4 compares and collates sentences which are extracted as important sentences and which are not erased by double lines with each other, and extracts a part which is denoted by reference numeral 21 and is underlined as a difference. In the process image 21 in FIG. 6, a difference extraction part is underlined. However, this is made to make it easy to understand the difference extraction part. An underlining operation to a character string is not always executed by the difference extraction section 4.

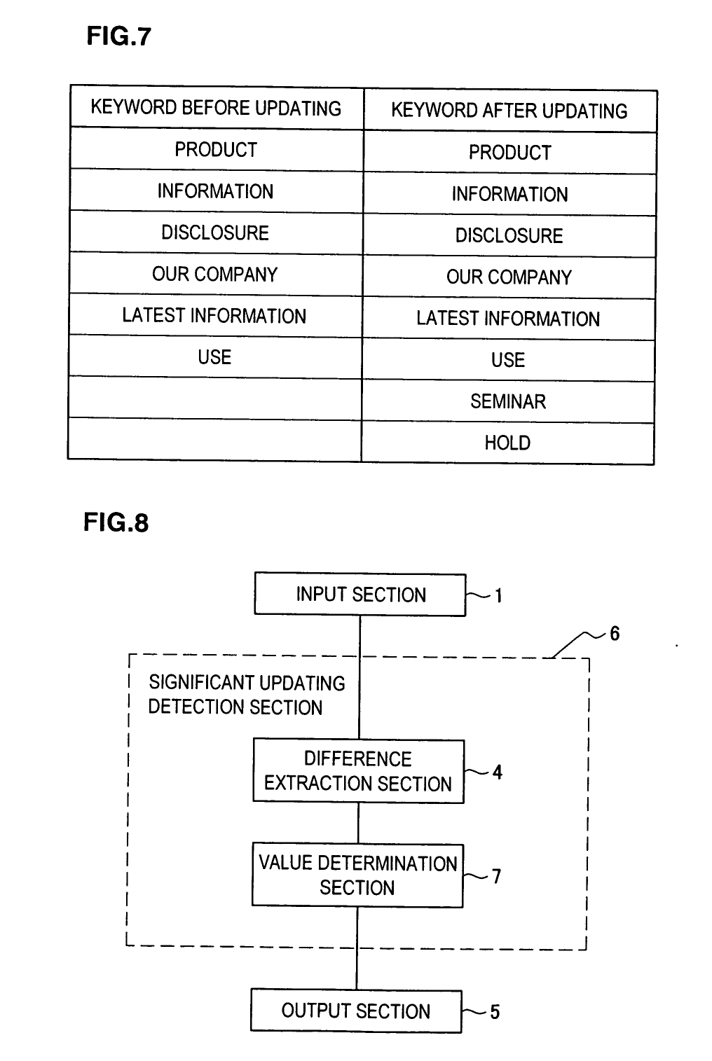

As another method (adding method) of the pre-process section 3, a method of removing a slight adjustment or the like by using keyword extraction can be cited. In the keyword extraction, for example, when a keyword is defined as “continuous characters of kanji and kana surrounded by different character codes”, a keyword extraction result for the Web pages shown in FIGS. 2 and 3 and obtained before and after updating is shown in FIG. 7. Changed parts (“site map” and “e-mail”) of frames 13 and 15 of the Web pages obtained before and after updating are not extracted because the change parts cannot serve as keywords in the above definition. When the keyword extraction results as shown in FIG. 7 are compared with each other by the difference extraction section 4, it can be checked whether updating is performed or not. In use of only the keyword extraction, only “will be held” is changed into “was held” in an article on January 1 in the frame 14 in FIGS. 2 and 3, keywords obtained before and after the change are not different from each other. This is a slight adjustment. It is determined that significant updating is not performed.

The output section 5, on the basis of the result of the difference extraction section 4, outputs data representing that a target Web page is significantly updated. For example, the output section 5 notifies a user that a target Web page is significantly updated.

Notification for a user can be performed by notification or the like performed by display on a display device or an e-mail. The notification contents may be the URL of a target Web page or information of a frame which detects a change, or may include concrete change contents. Notification for a user may be performed at a timing at which a user will pick up the corresponding Web page.

The presence of a buffer in which information of a Web page obtained before updating is stored in advance and timers for acquiring target Web pages at arbitrary timings can be easily understood, so that a description of the presence will be omitted. The information of the Web page obtained before updating and stored in the buffer may be raw data of the Web page or may be data obtained after the process is performed by the pre-process section 3.

(A-3) Effect of First Embodiment

As described above, according to the first embodiment, the pre-process section 3 extracts important parts from electronic documents obtained before and after target updating. The difference extraction section 4 can detect changes of the important parts as significant updating. In this manner, the output section 5 can notify a user that the significant updating is performed.

When the pre-process section 3 uses keyword extraction, the difference extraction section 4 can recognize that a slight adjustment is not a target to be detected, and only true significant updating can be detected.

(B) Second Embodiment

The second embodiment of an electronic document significant updating detection apparatus, method, and program and a recording medium on which the electronic document significant updating detection program according to the present invention is recorded will be described below with reference to the accompanying drawings.

(B-1) Configuration of Second Embodiment

FIG. 8 is a block diagram showing a functional configuration of an electronic document significant updating detection apparatus according to the second embodiment.

For example, the electronic document significant updating detection apparatus according to the second embodiment is also realized on an information processing apparatus such as user's personal computer having a communication function, a provider server, or the like. The electronic document significant updating detection apparatus can be functionally shown in FIG. 8. An electronic document significant updating detection program on a recording medium may be installed to structure the electronic document significant updating detection apparatus according to the second embodiment. In fact, the electronic document significant updating detection apparatus may be structured on one system, or may be structured such that electronic document significant updating detection apparatuses on servers which are connected to each other through a network cooperatively operate.

Like the electronic document significant updating detection apparatus according to the first embodiment, the electronic document significant updating detection apparatus according to the second embodiment is roughly constituted by an input section 1, a significant updating detection section 6, and an output section 5. The internal configuration of the significant updating detection section 6 is different from that of the first embodiment, and the input section 1 and the output section 5 are the same as those in the first embodiment.

The significant updating detection section 6 according to the second embodiment also detects significant updating of an electronic document such as a Web page. However, the significant updating detection section 6 according to the second embodiment has a difference extraction section 4 and a value determination section 7.

The difference extraction section 4 detects a difference by the same method as in the first embodiment. However, the second embodiment is different from the first embodiment in that a difference extraction target is an entire electronic document.

The value determination section 7 determines whether the difference extracted by the difference extraction section 4 is significant or not, and extracts only a significant difference. The value determination section 7 determines a significant difference by using a comparing process between a difference amount (e.g., the number of characters of a difference) with a threshold value or attribute determination performed by natural language processing such as morphological analysis.

(B-2) Operation of Second Embodiment

Detailed processes in the second embodiment will be described below by using imaginary Web pages shown in FIGS. 2 and 3 and obtained before and after updating.

As described above, the significant updating detection section 6 includes the difference extraction section 4 and the value determination section 7. The difference extraction section 4 extracts a difference in an entire document, and the value determination section 7 determines the significance of the extraction result.

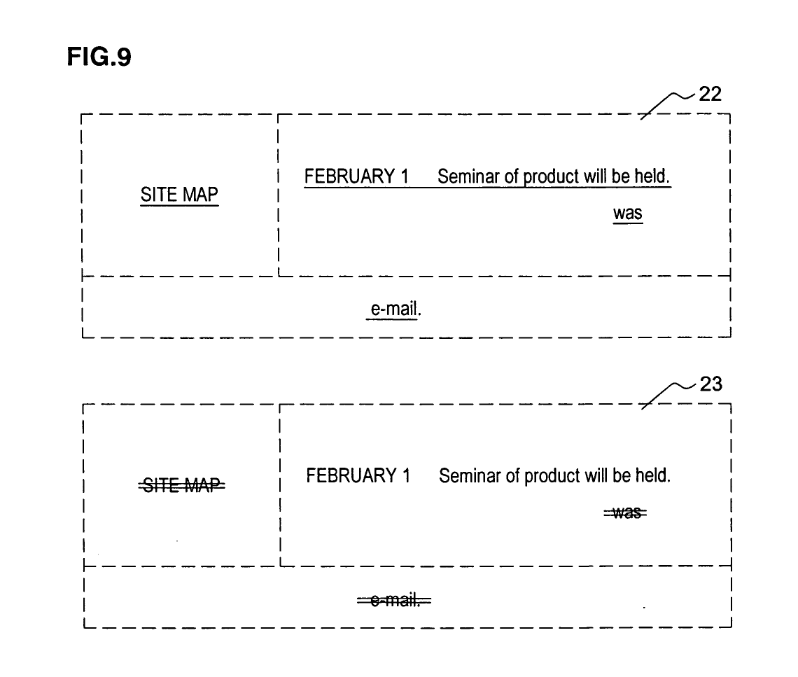

The second embodiment is different from the first embodiment in that a difference extraction target is an entire electronic document. However, the difference extraction method itself achieved by the difference extraction section 4 is the same as that in the first embodiment, and a description thereof will be omitted. A difference value determination process achieved by the value determination section 7 will be described below. Reference numeral 22 in FIG. 9 denotes a difference extracted by the second difference extraction section 4 from the Web pages shown in FIGS. 2 and 3 and obtained before and after updating.

The difference value determination process achieved by the value determination section 7 will be described below with reference to a difference value determination process using a comparing process between a difference amount and a threshold value and a difference determination process using attribute determination performed by natural language processing such as morphological analysis.

In the difference value determination process using a comparing process between a difference amount and a threshold value, a difference is determined as a valuable difference (significant difference) when character string lengths (the number of characters, the number of characters which are replaced with full-size characters, or the like) of respective differences exceed a certain threshold value.

If a difference including characters the number of which is 10 or more is determined as an effective (significant) difference (threshold value is 10), differences: “site map”; “was”; and “e-mail” in a difference extraction result in FIG. 9 are not determined as significant differences. On the other hand, a difference “. . . will be held on February” is significant difference. As a result, a determination result obtained by the value determination section 7 is a character string which is not erased by a double line in a part indicated by reference numeral 23 in FIG. 9. In other words, when a character string including characters the number of which is smaller than the threshold value is erased (see a double line part), the value determination section 7 determines that a definite sentence is valuable.

In the difference value determination process using attribute determination performed by natural language processing such as morphological analysis, a difference 22 given by the difference extraction section 4 and shown in FIG. 9 is divided into some parts, and a value (significant difference) is determined on the basis of the attributes of the respective parts. For example, a part (for example, a postpositional word functioning as an auxiliary to a main word, a single part of speech, or the like) which does not constitute a sentence is defined as an unnecessary part to determine the value. A determination result obtained in this case is also expressed by contents denoted by reference numeral 23 in FIG. 9, and an unnecessary part (see a double line) is deleted, so that it is determined that a definite sentence is valuable. Note that a date is understood such that the date recognized as a part of a sentence when the date is connected to the sentence through a space.

A character string which is determined by the value determination section 7 to be valuable (significant part) is given to the output section 5. The output section 5 outputs the character string as in the first embodiment.

As in the description of the second embodiment, the presence of a buffer in which information of a Web page obtained before updating is stored in advance and timers for acquiring target Web pages at arbitrary timings can be easily understood, so that a description of the presence will be omitted.

(B-3) Effect of Second Embodiment

As described above, according to the second embodiment, when value determination is performed to a difference character string of a target document in the value determination section 7, a slight adjustment or the like of a document can be eliminated from updating information. In this manner, the significant updating detection section 6 detects only significant information of updating contents of a target document, and the output section 5 can output the updating contents to a user or the like.

(C) Another Embodiment

The first embodiment and the second embodiment can be used in a system for monitoring a Web page or a text document in the Internet or an intranet. In this case, a traffic of respective accesses made by a large number of users can be reduced on the system side, and time and labor required for circulation of sites can be reduced on the user side.

In the first and second embodiment, it may be detected whether significant updating is performed or not, and data representing that the significant updating is performed or not may be output. Information which is determined as significant information may be output.

The technical scope of the first embodiment and the technical scope of the second embodiment may be independently applied to a system, or may be simultaneously applied to the system.

The process used in the pre-process section 3 of the first embodiment may be arranged in the process of the value determination section 7 of the second embodiment. In contrast to this, the process used in the value determination section 7 of the second embodiment may be arranged in the process of the pre-process section 3 of the first embodiment. These designs can cope with reinforcement of the processes or detailed processes of sites.

In addition, the respective embodiments are designed such that update information in an electronic document obtained after updating is output. However, update information in an electronic document obtained before updating may be output, both the pieces of update information may be output.

Furthermore, two electronic document for extracting a significant difference may be obtained at arbitrary timings. One of the electronic documents is not limited to the latest electronic document.

The example in which a difference can be extracted has been described. However, in the absence of a difference, data representing the absence of a difference may be output. An embodiment in which an output notifies a user of the absence of a difference, the output may not notify the user of the absence of a difference. When the difference is the whole of one of the electronic documents or an entire predetermined frame, data representing that both the documents are not compared and collated with each other may be output.

As described above, according to the present invention, updating the level of which is equal to the level of updating of an electronic document can be detected.

What is claimed is:

1. An electronic document significant updating detection apparatus comprising:
input means for loading an electronic document to be detected and an electronic document to be compared; and
significant updating detection means for detecting a difference between an important part of the input electronic document to be detected and an important part of the input electronic document to be compared.

2. An electronic document significant updating detection apparatus according to claim 1, wherein the significant updating detection means comprises a pre-process section for extracting important parts from the electronic document to be detected and the electronic document to be compared, and a difference extraction section for performing difference extraction to a result extracted by the pre-process section.

3. An electronic document significant updating detection apparatus according to claim 2, wherein the pre-process section determines the important parts by checking whether the important parts include a predetermined keyword or not.

4. An electronic document significant updating detection apparatus according to claim 1, wherein the significant updating detection means comprises a difference extraction section for extracting a difference between the electronic document to be detected and the electronic document to be compared, and a value determination section for determining whether the extracted difference is a significant difference or not.

5. An electronic document significant updating detection apparatus according to claim 4, wherein the value determination section determines whether the difference is a significant difference or not by using attribute determination or the like performed by natural language processing such as morphological analysis.

6. An electronic document significant updating detection apparatus according to claim 1, wherein the significant updating detection means comprises a pre-process section for extracting important parts from the electronic document to be detected and the electronic document to be compared, a difference extraction section for extracting a difference between the results extracted by the pre-process sections, and a value determination section for determining whether the extracted difference is a significant difference or not.

7. An electronic document significant updating detection apparatus according to claim 6, wherein the pre-process section determines the important parts by checking whether the important parts include a predetermined keyword or not.

8. An electronic document significant updating detection apparatus according to claim 6, wherein the value determination section determines whether a difference is a significant difference or not by using attribute determination or the like performed by natural language processing such as morphological analysis.

9. An electronic document significant updating detection apparatus according to claim 1, further comprising output means for notifying an external information processing apparatus of a detection result of the significant updating detection means.

10. An electronic document significant updating detection method comprising:
the input step of loading an electronic document to be detected and an electronic document to be compared; and
the significant updating detection step of detecting a difference between an important part of the input electronic document to be detected and an important part of the input electronic document to be compared.

11. An electronic document significant updating detection method according to claim 10, wherein the significant updating detection step comprises a pre-process for extracting important parts from the electronic document to be detected and the electronic document to be compared, and a difference extraction process for performing difference extraction to a result extracted by the pre-process.

12. An electronic document significant updating detection method according to claim 11, wherein, in the pre-process, the important parts are determined by checking whether the important parts include a predetermined keyword or not.

13. An electronic document significant updating detection method according to claim 10, wherein the significant updating detection step comprises a difference extraction process for extracting a difference between the electronic document to be detected and the electronic document to be compared, and a value determination process for determining whether the extracted difference is a significant difference or not.

14. An electronic document significant updating detection method according to claim 13, wherein, in the value determination process, it is determined by using attribute determination or the like performed by natural language processing such as morphological analysis whether the difference is a significant difference or not.

15. An electronic document significant updating detection method according to claim 10, wherein the significant updating detection step comprises a pre-process for extracting important parts from the electronic document to be detected and the electronic document to be compared, a difference extraction process for extracting a difference between the results extracted by the pre-process sections, and a value determination process for determining whether the extracted difference is a significant difference or not.

16. An electronic document significant updating detection method according to claim 15, wherein, in the pre-process the important parts are determined by checking whether the important parts include a predetermined keyword or not.

17. An electronic document significant updating detection method according to claim 15, wherein, in the value determination process, it is determined by using attribute determination or the like performed by natural language processing such as morphological analysis whether a difference is a significant difference or not.

18. An electronic document significant updating detection method according to claim 10, further comprising an output process for notifying an external information processing apparatus of a detection result in the significant updating detection step.

19. An electronic document significant updating detection program, wherein the respective steps of the electronic document significant updating detection method according to claim 10 are described in a code which can be processed by a computer.

20. A recording medium wherein the electronic document significant updating detection program according to claim 19 is recorded on the recording medium.
